(19) United States
(12) Patent Application Publication
(10) Pub. No.: US 2026/0292579 A1
(43) Pub. Date: Sep. 24, 2026

(54) DISTRIBUTED ANTENNA SYSTEM USING ANTENNA PORTS

(71) Applicant: Outdoor Wireless Networks LLC, Claremont, NC (US)

(72) Inventor: Van Erick Hanson, Forest, VA (US)

(73) Assignee: Outdoor Wireless Networks LLC, Richardson, TX (US)

(21) Appl. No.: 19/472,364

(22) PCT Filed: Mar. 18, 2024
(86) PCT No.: PCT/US2024/020447

§ 371 Date: Oct. 3, 2025

Related U.S. Application Data
(60) Provisional application No. 63/498,899, filed on Apr. 28, 2023.

(51) Int. Cl. H04W 28/02; H04W 24/08; H04W 88/08

(52) U.S. Cl. CPC H04W 28/0205; H04W 24/08; H04W 88/085

(57) ABSTRACT

A communication system is provided that includes a plurality of interface cards of a distributed antenna system that are configured to process data streams. Each interface card has resources to process the data streams including a plurality of interface antenna ports to receive and transmit the data streams. At least one base station entity has a plurality of base station antenna ports that are configured to transmit and receive the data streams. Each data base entity is configured to split the data streams into data sub-streams that are communicated between the plurality of base station antenna ports and interface antenna ports of at least two interface cards of the plurality of interface cards when one of the interface cards of the plurality of interface cards does not have enough resources to accommodate the data streams from the at least one base station entity.

### CROSS-REFERENCE TO RELATED APPLICATIONS

This Application claims priority to U.S. Provisional Application Ser. No. 63/498,899, same title herewith, filed on Apr. 28, 2023, which is incorporated in its entirety herein by reference.

### BACKGROUND

A distributed antenna system (DAS) is commonly used to provide enhanced cellular phone coverage in an indoor environment that frequently have insufficient coverage from outdoor cellular base stations due to increased signal attenuation caused by building structures. A DAS system is commonly comprised of multiple access points with radio antennas that are distributed throughout the building. A base station downlink wireless signal may be captured and distributed by cables to the multiple access points of the DAS which then retransmits the signal within the building. Likewise for the cellular uplink, the distributed radio antennas of the access points capture the uplink wireless signal from user equipment, such as mobile phones and these signals are amplified and routed by the cables back to the base station receiver equipment. In some implementations, distribution is achieved between the radio antennas and the base station equipment using electrical signals on electrically conductive cables either as RF or digital signals. In other implementations the distribution is achieved between the radio antennas and the base station equipment using optical signals carried on optical fiber cables.

Donor cards may be used to couple each base station entity to a node of the DAS (for example, a central access node of the DAS). The various nodes of the DAS may also include one or more distribution cards that are used to communicatively couple each node to other nodes of the DAS or to access points of the DAS.

A DAS implements specific transmission modes in communication information between antenna ports of components of the DAS. An example of a transmission mode is a multiple-in-multiple-out (MIMO) transmission mode for signal communications. For example, MIMO channels may be used in a physical transport link (fiber, or CAT cable) from a base station entity such as distribution unit (DU) or base band unit (BBU) to an access point of the DAS. Communication signals in channels received from base station entity may be in a digital format and are usually sent on one physical transport link to a donor card in a central access node. The donor card needs to have processing resources to process information received from a base station entity.

For the reasons stated above and for other reasons stated below which will become apparent to those skilled in the art upon reading and understanding the present specification, there is a need for a DAS with components that are configured to process high bandwidth (BW) signals and/or many data streams in an efficient and effective manner.

### SUMMARY

The following summary is made by way of example and not by way of limitation. It is merely provided to aid the reader in understanding some of the aspects of the subject matter described. Embodiments provide DAS configured to share processing resources of donor cards to effectively and efficiently communicate information throughout components of the DAS.

In one example, a method of operating a communication system is provided. The method includes determining if a first interface card in a distributed antenna system (DAS) has available resources to process a data stream; splitting the data stream when the first interface card does not have the available resources to process the data stream into data sub-streams; communicating a first data sub-stream of the split data sub-streams to the first interface card; communicating a second sub-stream of the split data sub-streams to at least one second interface card; and communicating system-plane data associated with the data stream to each of the first interface card and the second interface card.

In another example, a communication system including a plurality of interface cards and at least one base station entity is provided. The plurality of interface cards are within a distributed antenna system (DAS) and are configured to process data streams. Each interface card has resources to process the data streams including a plurality of interface antenna ports to receive and transmit the data streams. Each base station entity has a plurality of base station antenna ports configured to transmit and receive the data streams. Each data base entity is configured to split the data streams into data sub-streams to communicate between the plurality of base station antenna ports and interface antenna ports of at least two interface cards of the plurality of interface cards when one of the interface cards of the plurality of interface cards does not have enough resources to accommodate the data streams from the at least one base station entity.

In yet another example, a communication system that includes at least one base station entity, a central access node (CAN) of a distributed antenna system (DAS), and a plurality of access points is provided. The CAN includes a plurality of donor cards. Each donor card has select resources that include a plurality of antenna ports. Each donor card of the CAN is in communication with a base station entity of the at least one base station entity. The base station entity of the at least one base station entity is configured to use antennas ports of more than one donor card of the plurality of donor cards when a donor card of the plurality of donor cards does not have enough resources to accommodate a data stream from the base station entity of the at least one base station entity. One of the CAN and the at least one base station entity is configured to convey system-plane data associated with the data stream to each donor card that receives a data sub-stream of the data stream from the base station entity. The plurality of access points are in communication with the CAN. Each access point configured to be in wireless communication with user equipment.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a DAS that shares donor card processing resources according to an example aspect of the preset invention.

FIG. 2 is sub-rack of a node of a DAS, according to an example aspect of the preset invention.

FIG. 3 is a simplified block diagram of a plurality of base station entities and a portion of a DAS illustrate resources available in donor cards in an example aspect of the preset invention.

FIG. 4 is a simplified block diagram of a plurality of base station entities portion of a DAS illustrating a split data stream to take advantage of resources available in multiple donor cards in an example aspect of the preset invention.

FIG. 5 is a simplified block diagram of a base station entity and a portion of a DAS illustrating a split data stream to take advantage of resources available in multiple donor cards in an example aspect of the preset invention.

FIG. 6 is a simplified block diagram of a base station entity and a portion of a DAS illustrating a split data stream to take advantage of resources available in multiple donor cards in an example aspect of the preset invention.

FIG. 7 is a simplified block diagram of a base station entity and a portion of a DAS illustrating a split data stream to take advantage of resources available in multiple donor cards in an example aspect of the preset invention.

FIG. 8 is a flow diagram illustrating a method of spiting data streams and communicating system-plane data in a communication system according to one aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments provide a communication system that includes at least one base station entity and a DAS that is configured to share processing resources of interface cards, such as donor cards, to communicate information effectively and efficiently throughout components of the DAS.

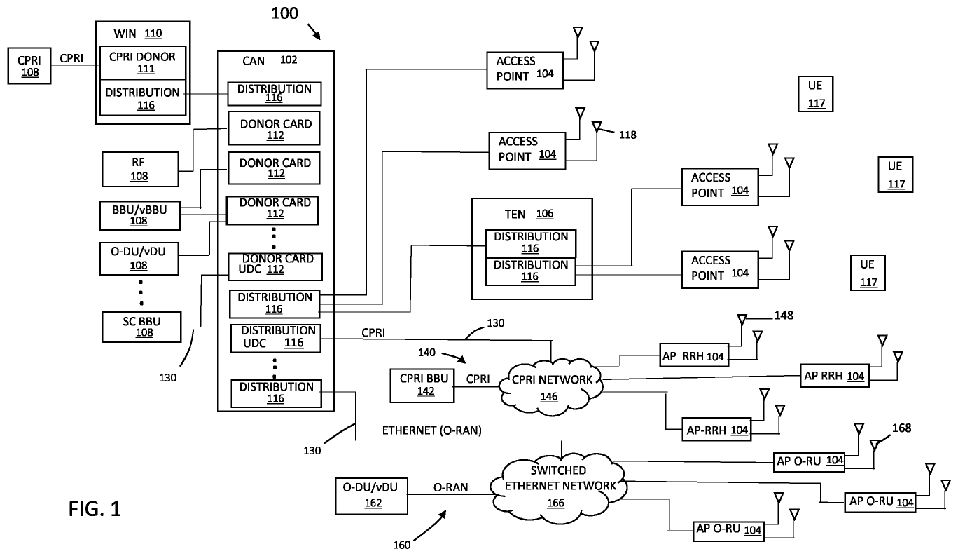

FIG. 1 illustrates a block diagram of a DAS 100 that shares interface card processing resources of one example. In this example, the DAS 100 includes one or more central access nodes (CANs) 102 (also referred to as “master units,” “host units,” or “hub units”) that are communicatively coupled to a plurality of remotely located access points 104 (also referred to as “antenna units,” “radio units,” “remote units,” or “remote antenna units”), where each access point 104 can be coupled directly to one or more of the central access nodes 102 or indirectly via one or more other access point 104 and/or via one or more transport expansion nodes (TENs) 106 (also referred to as “intermediary” or “expansion” units or nodes).

As discussed above, a DAS 100 is typically used to improve the coverage provided by one or more base station entities 108 that are coupled to the central access nodes 102. Each base station entity 108 coupled to the DAS 100 is typically served by one or more access points 104 of the DAS 100. By using such a simulcast approach, the DAS 100 increases the coverage area for the capacity provided by that base station entity 108.

The base station entities 108 can be coupled to the one or more central access nodes 102 via one or more cables or via a wireless connection (for example, using one or more donor antennas). DAS 100 can also include one or more wide-area integration nodes (WINs) 110 (also referred to as “host-to-host” nodes) that are used to communicatively couple remotely located base station entity 108 to the DAS 100 (more specifically, to one or more CANs 102 of the DAS 100).

A wireless service provided by the base station entity 108 can include commercial cellular service and/or private or public safety wireless communications.

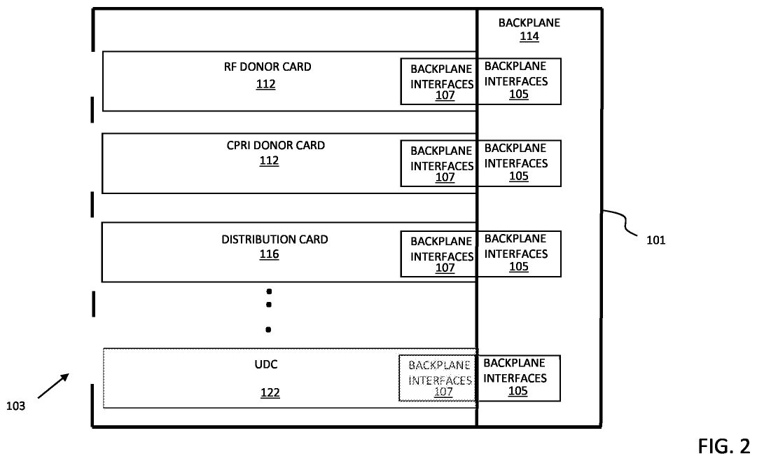

In this exemplary embodiment, each node of the DAS 100 includes a sub-rack 101 (shown in FIG. 2) having multiple slots 103 into which various types of interface cards can be inserted. In this exemplary embodiment, the sub-rack 101 also comprises a backplane 114. As shown in FIG. 2, the backplane 114 comprises a set of one or more backplane interfaces 105 for each slot 103 of the sub-rack 101 that is configured to be connected to (or otherwise interface with) a corresponding set of one or more backplane interfaces 107 of an interface card that is inserted into that slot 103. The backplane interfaces 105 on the backplane 114 and the backplane interfaces 107 of the cards inserted into the slots 103 of the sub-rack 101 are used to couple the components of the cards to the components of the backplane 114. In this way, the cards inserted into the slots 103 of the sub-rack 101 can communicate with the backplane 114 and, via the backplane 114, with other cards inserted into that sub-rack 101.

In this exemplary embodiment, each backplane 114 comprises an active backplane that is configured to process, format, and route data communicated between the cards inserted into the sub-rack 101. For example, each backplane can be implemented using one or more programmable devices that execute, or are otherwise programmed or configured by, software, firmware, or configuration logic in order to implement the functionality described here as being performed by the backplane. The one or more programmable devices can be implemented in various ways (for example, using programmable processors (such as microprocessors, co-processors, and processor cores integrated into other programmable devices) and/or programmable logic (such as field programmable gate arrays (FPGAs) and system-on-chip packages)). Where multiple programmable devices are used, all of the programmable devices do not need to be implemented in the same way. The backplane 114 can be implemented in other ways. For example, the backplane 114 could be implemented as a passive backplane, in which case the processing described here as being performed by the backplane 114 would be performed by one or more of the cards inserted into the slots 103 of the sub-rack 101.

In general, each node of the DAS 100 to which a base station entity 108 is first coupled to (for example, a CAN 102 or a WIN 110) includes interface cards that include one or more donor cards 112. Each donor card 112 is configured to couple one or more base station entities 108 to that node (and, more generally, to the DAS 100) over an external communication link (the link being “external” in the sense that it is external to the node). More specifically, each donor card 112 is configured to receive downlink data from each base station entity 108 coupled to that donor card 112 in a format suitable for use with the particular type of base station entity coupled to that donor card 112, convert the received downlink data to a digital fronthaul interface format suitable for communicating over a backplane of the node (and otherwise natively used in the DAS 100 more generally), and communicate the converted data to the backplane of the node for processing, formatting, and/or routing. Also, each donor card 112 is configured to receive uplink data from the backplane 114 of the node in the digital fronthaul interface format natively used in the DAS 100, convert the received uplink data to the format suitable for use with the particular type of base station entity 108 coupled to that donor card 112, and communicate the converted uplink data to an appropriate base station entity 108. In the exemplary embodiment described here in connection with FIG. 1, the digital fronthaul interface format natively used in the DAS 100 comprises a proprietary synchronous time-domain baseband in-phase and quadrature (IQ) fronthaul interface (also referred to as a fronthaul interface using an “Option 8 functional split”) that can be communicated over cabling using Ethernet physical layer devices.

One specific type of donor card 112 shown in FIG. 1 is an RF donor card 112 that is configured to couple a node (and, more generally, the DAS 100) to base station entities 108 using the external analog radio frequency (RF) interface of each base station entity 108 that would otherwise be used to couple the base station entity 108 to one or more antennas (if the DAS 100 were not being used).

Each RF donor card 112 is configured to receive downlink data from each base station entity 108 coupled to that RF donor card 112 in the form of analog downlink RF signals, convert the received analog downlink RF signals to the digital fronthaul interface format natively used in the DAS 100 (for example, by digitizing, digitally down-converting, and filtering the received analog downlink RF signals), and communicate the converted data to the backplane of the node for processing, formatting, and/or routing by the backplane 114. Also, each RF donor card 112 is configured to receive uplink data from the backplane 114 in the digital fronthaul interface format natively used in the DAS 100, convert the received uplink data to analog uplink RF signals (for example, by digitally up-converting and performing a digital-to-analog process), and communicate the analog uplink RF signals to appropriate base station entities 108.

Another specific type of donor card 112 shown in FIG. 1 is a digital donor card that is configured to communicatively couple the node (and, more generally, the DAS 100) to base station entities 108 (more specifically, a baseband units (BBUs)) using a digital baseband fronthaul interface that would otherwise be used to couple each BBU to an access point that is a remote radio head (RRH) (if the DAS 100 were not being used). The BBU may be a virtual BBU in an example. In one implementation, the digital baseband fronthaul interface comprises a time-domain baseband IQ fronthaul interface implemented in accordance with the Common Public Radio Interface (“CPRI”) specification. Other digital donor cards can be configured to use other digital baseband fronthaul interfaces. Each donor card 112 that is digital is configured to receive downlink data from each BBU (CPRI BBU in an example) coupled to that donor card 112 in the digital baseband fronthaul interface format used by that BBU, convert the received downlink data to the digital fronthaul interface format natively used in the DAS 100 (for example, by re-sampling, synchronizing, combining, separating, gain adjusting, etc.), and communicate the converted data to the backplane 114 of the node for processing, formatting, and/or routing by the backplane 114. Also, each donor card 112 that is digital is configured to receive uplink data from the backplane 114 of the node in the digital fronthaul interface format natively used in the DAS 100, convert the received uplink data to the digital baseband fronthaul interface format used by the BBUs coupled to that donor card 112 (for example, by re-sampling, synchronizing, combining, separating, gain adjusting, etc.), and communicate the converted uplink data to appropriate BBUs.

Further another example of a base station entity 108 is an open radio access network O-RAN distributed units (O-DUs) or virtualized O-DUs (vDUs) base station entity 108 that is configured to communicate over the external communication link 130, illustrated in FIG. 1, using an O-RAN fronthaul interface format, or small cell BBUs (SC BBUs) that are configured to communicate over the external communication link 130 using a proprietary frequency-domain baseband IQ fronthaul interface format configured for use over a switched Ethernet network. The access point 104 used in this example is an O-RAN remote unit (O-RU). Other types of base station entities may be used.

A distribution card 116, another example of an interface card, can be used to communicatively couple the node into which the card 116 is inserted to an access point 104. In this case, the distribution card 116 receives downlink data intended for that access point 104 from the backplane 114 of the node that the card 116 is inserted into and transmits the received downlink data over the external communication link (and associated cabling) used to couple the distribution card 116 to that access point 104. The data is communicated in the digital fronthaul interface format natively used in the DAS 100 (which in this exemplary embodiment comprises a proprietary synchronous time-domain baseband IQ fronthaul interface format that can be communicated over cabling using Ethernet physical layer devices). The downlink data transmitted to that access point 104 includes downlink data for each base station entity 108 served by that access point 104. The access point 104 receives the downlink data transmitted to it and uses the received downlink data to generate one or more downlink radio frequency signals for each base station entity 108 served by that access point 104 and radiates the one or more downlink radio frequency signals from one or more coverage antennas 118 associated with that access point 104 for reception by user equipment served by that base station entity 108.

Likewise, the access point 104, for each base station entity 108 served by that access point 104, receives uplink data transmitted from user equipment (UE) 117 served by that base station entity 108. The uplink user data is received as one or more analog uplink RF signals received via the one or more coverage antennas 118 associated with that access point 104. For each served base station entity 108, the access point 104 converts the associated received analog uplink RF signals to produce uplink data for that base station entity 108 in the digital fronthaul interface format natively used in the DAS 100. The access point multiplexes (frames) the uplink data for the various base station entities 108 served by that access point 104 and communicates the multiplexed uplink data over the external communication link (and associated cabling) used to couple the distribution card 116 to that access point 104. The distribution card 116 receives the uplink data transmitted from that access point 104 and communicates the received uplink data to the backplane 114 of the node that the card 116 is inserted into.

A distribution card 116 can be used to couple the node into which the card 116 is inserted to another node of the DAS 100 in different ways. A distribution card 116 can be used to couple the node into which the card 116 is inserted to another “downstream” node over an external communication link. For example, a distribution card 116 inserted into a CAN 102 can be used to couple the CAN 102 to a TEN 106 over an external communication link or inserted into a WIN 110 to couple the WIN 110 to a CAN 102 over an external communication link. If used in this way, the distribution card 116 receives downlink data intended for the downstream node from the backplane 114 of the node that the card 116 is inserted into and transmits the received downlink data to the downstream node over the external communication link (and associated cabling) used to couple the distribution card 116 to that downstream node. Likewise, the distribution card 116 receives uplink data transmitted from that downstream node via the external communication link (and associated cabling) and communicates the received uplink data to the backplane 114 of the node that the card 116 is inserted into.

A distribution card 116 can also be used to couple the node into which the card 116 is inserted to another “upstream” node over an external communication link. For example, a distribution card 116 inserted into a TEN 106 can be used to couple the TEN 106 to a CAN 102 over an external communication link or inserted into a CAN 102 to couple the CAN 102 to a WIN 110 over an external communication link. If used in this way, the distribution card 116 receives downlink data transmitted from that upstream node via the external communication link (and associated cabling) used to couple the distribution card 116 to that upstream node and communicates the received downlink data to the backplane 114 of the node that the card 116 is inserted into. Likewise, the distribution card 116 receives uplink data intended for that upstream node from the backplane 114 of the node that the card 116 is inserted into and transmits the received uplink data to the upstream node over the external communication link (and associated cabling) used to couple the distribution card 116 to that upstream node.

In the exemplary embodiment shown in FIG. 1, some of the distribution cards 116 are configured to communicate over optical cables and these distribution cards 116 are also referred to here as “optical distribution cards” 116. Also, in the example shown in FIG. 1, some of the distribution cards 116 are configured to communicate over copper cables (for example, twisted-pair cables or coaxial cables) and are also referred to here as “copper distribution cards” 116. In this example, the copper distribution cards 116 can also be configured to provide power to access points 104 (or other DAS nodes) over the copper cables (for example, using Power-over-Ethernet (POE) or direct current (DC) line-power techniques).

The backplane 114 used in the nodes of the DAS 100 comprises an active backplane that is configured to process, format, and route data communicated between the cards 112, 116, 122 inserted into each node. The backplane 114 replicates downlink data for each base station entity 108 as needed to communicate with the various access points 104 serving that base station entity 108 and performs a digital summation process for corresponding uplink baseband IQ samples received from the various access points 104 serving each base station entity 108. The backplane 114 multiplexes and demultiplexes data as needed to communicate it between the cards 112 and 116 inserted into each node.

Other types of interface cards can be inserted into the sub-rack 101 used to implement each node of the DAS 100. For example, the sub-rack 101 can be configured to include a dedicated slot 103 into which a system user interface card (not shown) can be inserted. The system user interface card is configured to implement a local management interface for the associated node. The system user interface card can include one or more Ethernet interfaces via which external devices or systems can be coupled to the system user interface card in order to communicate with the management interface implemented for the DAS 100. Also, the sub-rack 101 can be configured to include one or more dedicated slots 103 into which auxiliary transport cards (not shown) can be inserted. Each auxiliary transport card is configured to enable pass-through Ethernet connections to other IP devices (such as Wi-Fi access points or security cameras) that may be coupled to various nodes of the DAS 100, thereby enabling these IP devices to share the cabling infrastructure of the DAS 100.

Further in one example a general type of interface card that can be inserted into the slots 103 of the sub-rack 101 used to implement a node of the DAS 100 is a universal digital card (UDC). For example, each UDC can be inserted into a slot 103 of a sub-rack 101 used to implement a central access node (CAN), a transport expansion node (TEN), or a wide-area integration node (WIN) of the DAS 100. A UDC can be used as a donor card 112 or a distribution card 116. Each UDC donor card 112 and UDC distribution card 116 can be used with various types of base station entities 108. In contrast, the dedicated donor cards 112 described above are configured to be used with only one particular type of base station entity 108.

In general, each UDC (and the other cards, entities, and nodes described herein), and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Other embodiments can be implemented in other ways.

In the example of FIG. 1, a UDC distribution card 116 is used and configured to serve as a distribution card to couple the CAN 102 to a CPRI base station system 140 over one or more CPRI external communication links 130. In this use case, the CPRI system 140 comprises a CPRI baseband unit 142 that serves a set of access points 104 (CPRI remote radio heads (RRHs) units). Each RRH is coupled to a respective set of antennas 148. In this use case, the CPRI baseband unit 142 and CPRI RRHs communicate with each other over a CPRI network 146 using a CPRI time-domain baseband IQ fronthaul interface format.

For each CPRI external communication link 130, the additional UDC distribution card 116 converts between the digital fronthaul interface format natively used in the DAS 100 and the CPRI interface format used for communicating over that CPRI external communication link 130. By using an additional UDC in this way, an existing CPRI base station system 140 can be used with newer types of base station entities 108 that do not natively support being used with that type of CPRI base station system 140.

In another example, a UDC distribution card 116 is configured to serve as a distribution card is used to couple the CAN 102 to a O-RAN base station system 160 over one or more Ethernet external communication links 130. In this use case, the O-RAN system 160 comprises an O-DU/v-DU 162 that serves a set of access points 104, O-RUs in this example. Each O-RU is coupled to a respective set of antennas 168. In this use case, the O-DU/v-DU 162 and O-RUs communicate with each other over a switched Ethernet network 166 using an O-RAN fronthaul interface format. For each Ethernet external communication link 130, the additional UDC (serving as a distribution card 116) converts between the digital fronthaul interface format natively used in the DAS 100 and the O-RAN fronthaul interface format used for communicating over that Ethernet external communication link 130 and the switched Ethernet network 166.

As discussed above, embodiments allow for the sharing resources processing resources of donor cards to effectively and efficiently communication information throughout components of the DAS. For example, the BBU/vBBU base station entity 108 is illustrated as using the resources of two donor cards 112.

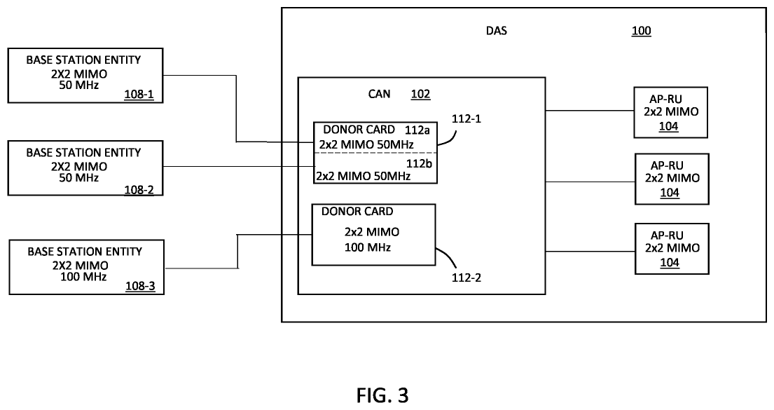

Referring to FIG. 3, a simplified block diagram of a portion of DAS 100 is provided to illustrate resources available at the CAN 102 of the DAS 100. As illustrated, the CAN 102 is in communication with a plurality of access points 104 which are RUs in this example. The access points 104 may be in wireless communication with UEs 117 (shown in FIG. 1) such as, both limited to, cellular phones. The CAN 102 in this example includes a first donor card 112-1 and a second donor card 112-2. Further illustrated are three base station entities 108-1, 108-2 and 108-3. In this example, the base station entities 108-1, 108-2 and 108-3 may include O-RAN distributed units (O-DUs) or virtualized O-DUs (vDUs) configured to communicate over the external communication link 130, illustrated in FIG. 1, using an O-RAN fronthaul interface format, or small cell BBUs (SC BBUs) that are configured to communicate over the external communication link 130 using a proprietary frequency-domain baseband IQ fronthaul interface format configured for use over a switched Ethernet network.

The donor cards 112-1 and 112-2 of the CAN 102 has the resources, in this example, to process up to 200 MHz of total BW. Different configurations of the donor cards (interface cards) may be used to provide the processing resources of the 200 MHz of total BW. For example, two donor cards having 2×2 (two antenna ports) at 100 MHz, two donor cards having 4×4 at 50 MHz or two donor cards having 10×10 at 20 MHz provides the 200 mHz resources. “Antenna ports” as referend to herein are generally baseband digital signals. Although a donor card 112 may have only one port, such as a single 10G or 25G ethernet “port,” on this single digital link, frequency/time domain signals for all the “antenna ports” are carried. For example, for a 4×4 carrier, all four signals destined for the four antenna ports would come in one digital port.

Further in an example that uses a MIMO transmission mode to communicate, the MIMO label is used to denote the number of antenna ports that are used for spatial multiplexing which is a technique used for increasing bitrate. Spatial multiplexing is achieved by splitting a signal into different data streams that are transmitted and received on spatially separated antennas on each side of the link.

In FIG. 3, the first base station entity 108-1, that has a 2×2 antenna port 50 MHz capacity, is connected to (or in communication with) a first resource portion 112a of the first donor card 112-1 that includes a 2×2 antenna port 50 MHz resource. The second base station entity 108-1, that also has a 2×2 antenna port 50 MHz capacity, is connected to (or in communication with) a second resource portion 112b of the first donor card 112-1 that includes a 2×2 antenna port 50 MHz resource. Hence, donor card 112-1 is able to share its resources to be in communication with both first and second base station entities 108-1 and 108-2. The third base station 108-3 with a capacity of 2×2 antenna port 50 MHz is in communication with the second donor card 112-2 which has the resources of 2×2 antenna port 50 MHz resource. The DAS 100 distributes the signals to the access points 104 which are RUs in this example, each having 2×2 antenna port capacity.

If, however, a base station entity 108 had a capacity of 4×4 antenna port 100 MHz, each donor card 112-1 or 112-2 of CAN 102 of FIG. 3 does not have the resources needed to process a 4×4 antenna port 100 MHz signal on its own. To allow the DAS 100 to accommodate the case where a donor card 112 does not have the resources to process an entire signal from a base station entity 108, embodiments divide a data stream into two or more data sub-streams to spread the processing load over multiple donor cards 112.

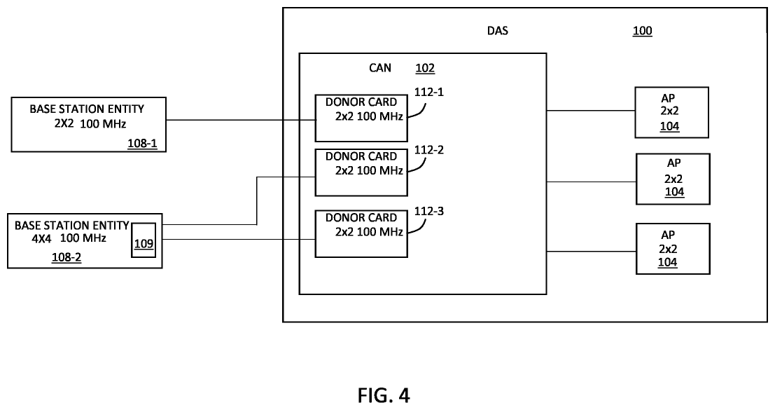

An example of a DAS 100 that divides data streams into data sub-streams to accommodate the need for more resources with the donor cards 112 is illustrated in the block diagram of FIG. 4. In the example of FIG. 4, the DAS includes a CAN 102 with three donor cards 112-1, 112-2 and 112-3. Each donor card 112-1, 112-2, and 112-3 in this example includes a 2×2 antenna port 100 MHz capacity. The CAN 102 is in communication with access points 104. Each access point in this example has a 2×2 antenna ports. Base station entity 108-1 in this example has a 2×2 antenna port 100 MHz capacity while base station entity 108-2 has a 4×4 antenna port 100 MHz capacity.

In the example of FIG. 4, base station entity 108-1 is in communication with donor card 112-1 since donor card 112-1 has the resources to accommodate the 2×2 antenna port 100 MHz capacity of base station entity 108-1. Further, to work within the processing constraints of the donor cards 112-1, 112-2 and 112-3 of the CAN 102, the data streams from base station entity 108-2 are split into data sub-streams with one data sub-stream being communicated to donor card 112-2 while the other data sub-stream is communicated to the donor card 112-3 to share the processing resources of donor cards 112-2 and 112-3 of CAN 102. In a MIMO example, if a MIMO data stream is sent from the two donor cards to the same access point 104, then in the uplink direction, the uplink MIMO data streams from the single access point 104 to the two donor cards 112-2 and 112-3 are split as well.

In one example, the base statin entity 108-2 uses a splitter/combiner 109 to split the data stream into data sub-streams. In one example, the splitter/combiner 109 includes a multiplexer/demultiplexer. In another example, the splitter/combiner 109 includes one or more switches. The base station entity 108 is configured to control of the spitter/combiner 109 to spit the data stream when needed. In one example, the base station entity 108 is preconfigured by a user to split the data stream. In another embodiment, the base station entity 108 is configured to split the data stream if the overall BW exceeds some defined level (either a RF channel BW or a digital BW defined level). Further in an embodiment, each donor cards 112 is configured to advertise the donor card resources to the base station entity 108. In this embodiment, if a channel that the base station entity 108 wanted to configure requires more resources that the advertised resources of a donor card 112, the base station entity 108 spits the data stream and directs at least one data sub-stream to a donor card 112 with available resources on another antenna port.

Data communicated through the data streams includes user-plane data and system-plane data that is used by components of the communication system to process the user-plane data in an effective and efficient manner. The user-plane data includes communication data intended to be communicated between the base station entities 108 and the UEs 117. Examples of system-plane data include management-plane data, synchronization-plane data, and control-plane data depending on the transmission mode. The management-plane data may include data relating to configuring, monitoring and management of protocol stacks implemented by components of a communication system (i.e., the components in the DAS) to achieve communication between the components. The synchronization-plane data may include data relating to information to synchronize the timing of communications between components in the communication system The control-plane data may include data relating to the routing of data to select components of the communication system.

Although, user-plane data can be split into data sub-streams without an issue, the other types of data (the system-plane data), typically cannot be split because a base station entity 108 typically communicates this type of data in only one instance, or occurrence. Hence, one data sub-stream in a split date stream might not include the system-plane data needed to effectuate communications between components of the communication system.

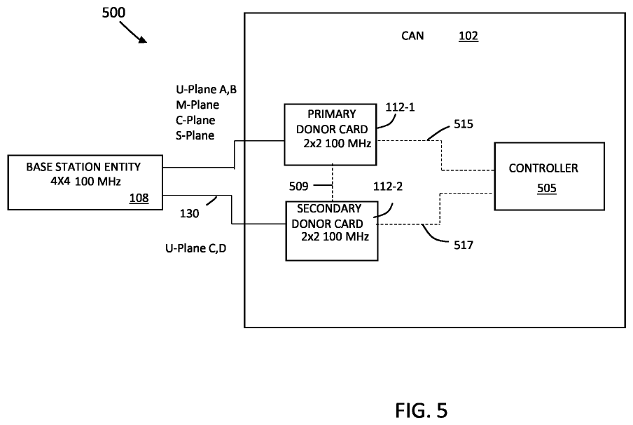

Referring to the split stream circuit 500 of FIG. 5, an example of how a split in data streams can be accomplished with system-plane data to share CAN 102 resources is provided. In this example, donor card 112-1 is designated as a primary donor card 112-1 and donor card 112-2 is designated as secondary donor card 112-2. Both the primary donor card 112-1 and the secondary donor card 112-2 of the CAN 102 have a 2×2 MIMO 100 MHz capacity. To accommodate the 4×4 MIMO 100 MHz capacity of the base station entity 108, the data streams are split into data sub-streams. First data sub-streams are communicated between the base station entity 108 and the primary donor card 112. In one example, the first data sub-streams are communicated between the base station entity 108 and the primary donor card 112 using at least one antenna port of the base station entity 108 and at least one antenna port of the primary donor card 112. The antenna ports may be digital data ports that pass the sub-streams to and from associated antennas. In one example, the primary and secondary donor cards 112 include a single port. On this single digital link provided by the port, frequency/time domain signals for all the “antenna ports” are carried as discussed above. The antenna ports are baseband digital signals. The first data sub-streams, in this example, includes user-plane data A and B as well as system-plane data that may include management-plane data, synchronization-plane data, and control-plane data (M/C/S-plane data).

Second data sub-streams are communicated between base station entity 108 and the secondary donor card 112-2. The second data sub-streams, in this example, includes user-plane data C and D.

As discussed above, components of the DAS 100 may need the system-plane data to effectuate communications throughout the system. In the split stream example of FIG. 5, the secondary donor card 112-2 did not receive the system-plane data through the communications between base station entity 108 and the secondary donor card 112-2. Hence, the secondary donor card 112-2 may not have communication, synchronization, and routing information needed to effectuate communications. Example embodiments provide the needed system-plane data to the secondary donor card 112-2.

One example embodiment, the primary donor card 112-1 forwards on the system-plane data to the secondary donor card 112-2 via communication link 509. Hence, in this example, the interface cards (donor cards) communication system-plane data between each other. In yet another example, a CAN controller 505 (or processor) of the CAN 102 that is in communication with the primary donor card 112-1 via communication link 515 and the secondary donor card 112-2 via communication link 517 reads the system-plane data at the primary donor card 112-2 and provides it to the secondary donor cards 112-2. Hence there are different ways in which the system-plane data that is only in one data sub-stream from the base station entity 108 can be retrieved and communicated to other components, such as the secondary donor card 112-2. Likewise, if uplink data from the secondary donor card 112-2 needed to be sent to base station entity 108, the information could be communicated via the primary donor card 112-1.

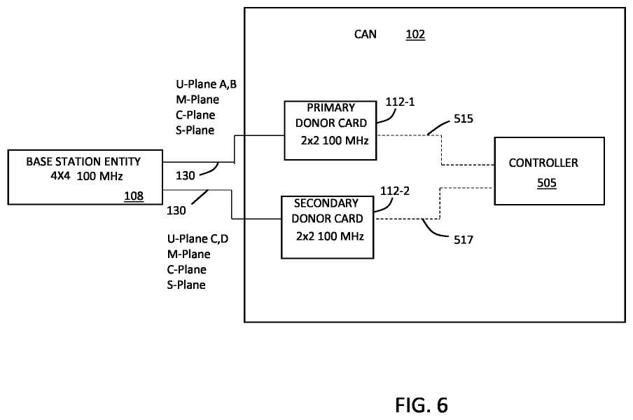

Another example where data streams are split into data sub-streams to take advantage of available resources in a CAN 102 is illustrated in FIG. 6. In this example, the base station entity 108 is configured generate (or replicate) separate system-plane data for each data sub-stream. Hence, both splits of the data stream from the base station entity 108 includes the system-plane data. In this example, the first split data sub-stream includes user-plane data A and B as well as the M/C/S plane data is communicated to the primary donor card 112-1 and the second split data sub-stream that includes the user-plane data C and D as well as the M/C/S plane data is communicated to the secondary donor card.

Further in an example, a combination of the example shown in FIG. 5 and the example shown in FIG. 6 may be used. In this example, some of the system-plane data may be contained in one or both of the data sub-streams from the base station entity 108. Any missing system-plane data needed by a donor card 112-1 or 112-2, in this example, is provided via either the other donor card 112-1 or 112-2 or the CAN controller 505.

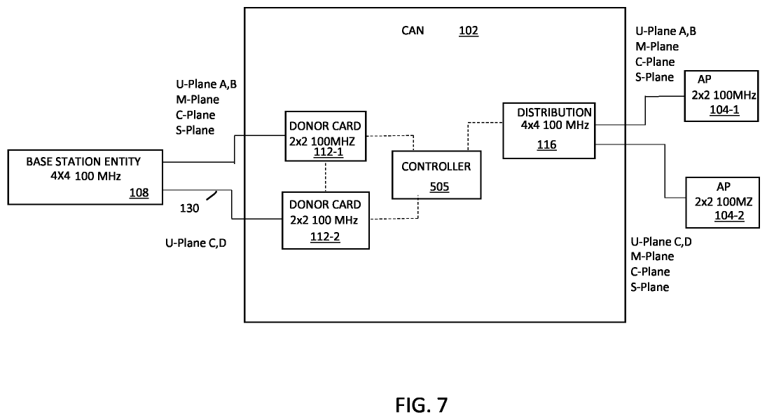

Although the above examples discuss examples where the shared resources of interface cards are donor cards 112 in a CAN 102 of the DAS, other interface cards of the DAS may also share resources when needed. For example, referring to FIG. 7, besides sharing the resources of donor cards 112-1 and 112-2, the resources of the access points 104-1 and 104-2 may also be shared. In this example, distribution card 116 of the CAN 102 has a 4×4 antenna port 100 MHz capacity while each access point 104-1 and 104-2 has a 2×2 antenna port 100 MHz resource available. In one example, the data streams are split at the distribution card 116 into data sub-streams that are respectively communicated to access points 104-1 and 104-2. In this example the CAN processor 102 may be configured to cause the distribution card 116 to provide the system-plane data to both of the data sub-streams so both access points 104-1 and 104-2 have the control information. Other methods of conveying the system-plane data as discussed above may be used. Hence, sharing resources of the interface card of the DAS is not limited to donor cards in a CAN.

Further, although the examples discussed above use 4×4 and 2×2, other examples may use higher order antenna ports, such as, but not limited, to 8×8 and 64×64. Further, examples allow for a date stream to be split to more than two donor cards 112 if needed.

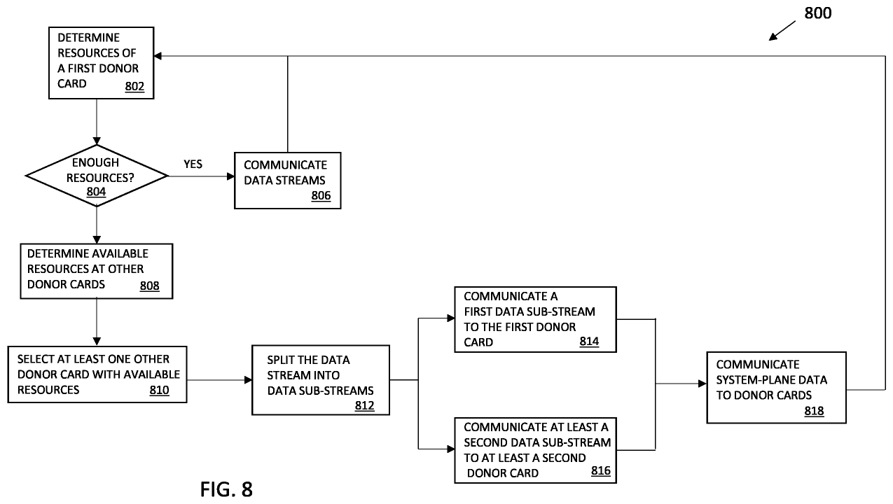

A method of sharing interface card resources in a communication system is provided in flow diagram 800 of FIG. 8. Flow diagram 800 is provided as a series of sequential blocks. The sequence of the block may occur in a different order or in parallel in other embodiments. Hence, embodiments are not limited to sequence set out in flow diagram 800 of FIG. 8.

Flow diagram starts at block 802 where available resources of a first donor card 112 in the CAN 102 that is in communication with a base station entity 108 is determined. It is determined at block 804 if the first donor card 112-1 has enough resources to handle data streams from the base station entity 108. If it is determined a block 804 that the first donor card 112-1 has enough resources, communication of the data streams between the base station entity 108 and the first donor card 112 proceeds at block 806. The process then continues at block 802.

If it is determined at block 804, that the first donor card 112 does not have enough resources, resources available at other donor cards is determined at block 808. In one example, the base station entity 108 is preconfigured by the user to determine if a split in data streams is needed to take advantage of resources at the donor card 112. In another example, the base station entity splits the data streams if an overall bandwidth exceeds some defined level (either RF channel BW or digital BW to the donor card 112). In still another embodiment, the donor card 112 is configured to advertise its capability to the base station entity 108. In this example, if a channel the base station entity 108 wanted to configure required more resources, then the advertised resources of a donor card 112, the base station entity 108 is configured to find additional resources with other antenna ports on another donor card 112.

At least one other donor card 112-2 with available resources is selected at block 810. The data stream from the base station 108 is split into at least two data sub-streams at block 812. First data sub-streams are communicated to the first donor card at block 814. The first donor card 112-1 with have enough resources to process the first data sub-stream. Second data sub-streams are communicated to the at least one other donor card at block 816.

At block 818, system-plane data is communicated to each donor cards processing the first data sub-streams and the second data sub-streams. As discussed above, this may be done by the donor cards 112-1 and 112-2 communicating with each other, by a controller 505 of the CAN 102, or by replicating the system-plane data so both data sub-streams include the system-plane data.

### EXAMPLE EMBODIMENTS

Example 1 includes a method of operating a communication system. The method includes determining if a first interface card in a distributed antenna system (DAS) has available resources to process a data stream; splitting the data stream when the first interface card does not have the available resources to process the data stream into data sub-streams; communicating a first data sub-stream of the split data sub-streams to the first interface card; communicating a second sub-stream of the split data sub-streams to at least one second interface card; and communicating system-plane data associated with the data stream to each of the first interface card and the second interface card.
Example 2 includes the method of Example 1, wherein the first interface card is a first donor card in a central access node (CAN) and the second interface card is a second donor card of a CAN.
Example 3 includes the method of any of the Examples 1-2, further comprising: generating the data stream with a base station entity.
Example 4 includes the method of any of the Examples 1-3, wherein communicating the system-plane data associated with the data stream further includes communicating the system-plane data between the first interface card and the second interface card.
Example 5 includes the method of any of the Examples 1-4, wherein communicating the system-plane data associated with the data stream further includes reading the system-plane data from one of the data sub-streams from one of the first interface card and the second interface card; and communication the system-plane data to another of the first interface card and second interface card.
Example 6 includes the method of any of the Examples 1-5, wherein the system-plane data includes at least one of management-plane data, control-plane data and synchronization-plane data.
Example 7 includes the method of any of the Examples 1-6, wherein determining if the first interface card in a distributed antenna system (DAS) has available resources to process a data stream further includes determining if an overall bandwidth exceeds a defined level that could be handled by an interface card.
Example 8 includes the method of any of the Examples 1-7, further comprising: advertising the resources of the interface card.
Example 9 includes a communication system including a plurality of interface cards, and at least one base station entity. The plurality of interface cards are within a distributed antenna system (DAS) and are configured to process data streams. Each interface card has resources to process the data streams including a plurality of interface antenna ports to receive and transmit the data streams. Each base station entity has a plurality of base station antenna ports configured to transmit and receive the data streams. Each data base entity is configured to split the data streams into data sub-streams to communicate between the plurality of base station antenna ports and interface antenna ports of at least two interface cards of the plurality of interface cards when one of the interface cards of the plurality of interface cards does not have enough resources to accommodate the data streams from the at least one base station entity.
Example 10 includes the communication system of Example 9, wherein at least two of the plurality of interface cards are within a plurality of access points of the DAS.
Example 11 includes the communication system of any of the Examples 9-10, wherein at least two interface cards of the plurality of interface cards are configured to share system-plane data associated with the data streams.
Example 12 includes the communication system of any of the Examples 9-11, wherein each interface card of the plurality of interface cards is configured to advertise the resources of the interface cards.
Example 13 includes the communication system of any of the Examples 9-12, wherein the plurality of interface cards are a plurality of donor cards within a central access node (CAN) of the DAS.
Example 14 includes the communication system of Example 13, further including a CAN controller configured to read system-plane data from the plurality of donor cards and share the system-plane data with donor cards of the plurality of the donor cards not receiving the system-plane data in the data sub-stream.
Example 15 includes the communication system of any of the Examples 9-14, wherein the at least one base station entity further includes at least one splitter/combiner configured to at least split the data streams into data sub-streams.
Example 16 includes the communication system of any of the Examples 9-15, wherein the base station entity is configured to determine that the one interface does not have enough resources based on an advertisement from the one interface card.
Example 17 includes the communication system of any of the Examples 9-16, wherein the base station entity is configured to determine that the one interface does not have enough resources when an overall bandwidth of the data stream exceeds a defined bandwidth that could be handled by an interface card.
Example 18 includes a communication system including at least one base station entity, a central access node (CAN) of a distributed antenna system (DAS) and a plurality of access points. The CAN includes a plurality of donor cards. Each donor card has select resources that include a plurality of antenna ports. Each donor card of the CAN is in communication with a base station entity of the at least one base station entity. The base station entity of the at least one base station entity is configured to use antennas ports of more than one donor card of the plurality of donor cards when a donor card of the plurality of donor cards does not have enough resources to accommodate a data stream from the base station entity of the at least one base station entity. One of the CAN and the at least one base station entity is configured to convey system-plane data associated with the data stream to each donor card that receives a data sub-stream of the data stream from the base station entity. The plurality of access points are in communication with the CAN. Each access point configured to be in wireless communication with user equipment.
Example 19 includes the communication system of Example 18, further wherein the base station entity is configured to replicate the system-plane data associated with the data stream within the data sub-streams.
Example 20 includes the communication system of any of the Examples 18-19, further wherein at least one first donor card of the plurality of donor cards is configured to communicate at least some of the system-plane data to at least one second donor card of the plurality of donor cards.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of operating a communication system, the method comprising:
determining if a first interface card in a distributed antenna system (DAS) has available resources to process a data stream;
splitting the data stream when the first interface card does not have the available resources to process the data stream into data sub-streams;
communicating a first data sub-stream of the split data sub-streams to the first interface card;
communicating a second sub-stream of the split data sub-streams to at least one second interface card; and
communicating system-plane data associated with the data stream to each of the first interface card and the second interface card.

2. The method of claim 1, wherein the first interface card is a first donor card in a central access node (CAN) and the second interface card is a second donor card of a CAN.

3. The method of claim 1, further comprising:
generating the data stream with a base station entity.

4. The method of claim 1, wherein communicating the system-plane data associated with the data stream further comprises:
communicating the system-plane data between the first interface card and the second interface card.

5. The method of claim 1, wherein communicating the system-plane data associated with the data stream further comprises:
reading the system-plane data from one of the data sub-streams from one of the first interface card and the second interface card; and
communication the system-plane data to another of the first interface card and second interface card.

6. The method of claim 1, wherein the system-plane data includes at least one of management-plane data, control-plane data and synchronization-plane data.

7. The method of claim 1, wherein determining if the first interface card in a distributed antenna system (DAS) has available resources to process a data stream further comprises:
determining if an overall bandwidth exceeds a defined level that could be handled by an interface card.

8. The method of claim 1, further comprising:
advertising the resources of the interface card.

9. A communication system comprising:
a plurality of interface cards within a distributed antenna system (DAS) configured to process data streams, each interface card having resources to process the data streams including a plurality of interface antenna ports to receive and transmit the data streams; and
at least one base station entity, each base station entity having a plurality of base station antenna ports configured to transmit and receive the data streams, each data base entity configured to split the data streams into data sub-streams to communicate between the plurality of base station antenna ports and interface antenna ports of at least two interface cards of the plurality of interface cards when one of the interface cards of the plurality of interface cards does not have enough resources to accommodate the data streams from the at least one base station entity.

10. The communication system of claim 9, wherein at least two of the plurality of interface cards are within a plurality of access points of the DAS.

11. The communication system of claim 9, wherein at least two interface cards of the plurality of interface cards are configured to share system-plane data associated with the data streams.

12. The communication system of claim 9, wherein each interface card of the plurality of interface cards is configured to advertise the resources of the interface cards.

13. The communication system of claim 9, wherein the plurality of interface cards are a plurality of donor cards within a central access node (CAN) of the DAS.

14. The communication system of claim 13, further comprising:
A CAN controller configured to read system-plane data from the plurality of donor cards and share the system-plane data with donor cards of the plurality of the donor cards not receiving the system-plane data in the data sub-stream.

15. The communication system of claim 9, wherein the at least one base station entity further comprises:
at least one splitter/combiner configured to at least split the data streams into data sub-streams.

16. The communication system of claim 9, wherein the base station entity is configured to determine that the one interface does not have enough resources based on an advertisement from the one interface card.

17. The communication system of claim 9, wherein the base station entity is configured to determine that the one interface does not have enough resources when an overall bandwidth of the data stream exceeds a defined bandwidth that could be handled by an interface card.

18. A communication system comprising:
at least one base station entity;
a central access node (CAN) of a distributed antenna system (DAS), the CAN including, a plurality of donor cards, each donor card having select resources that include a plurality of antenna ports, each donor card of the CAN in communication with a base station entity of the at least one base station entity, the base station entity of the at least one base station entity configured to use antennas ports of more than one donor card of the plurality of donor cards when a donor card of the plurality of donor cards does not have enough resources to accommodate a data stream from the base station entity of the at least one base station entity, one of the CAN and the at least one base station entity configured to convey system-plane data associated with the data stream to each donor card that receives a data sub-stream of the data stream from the base station entity; and
a plurality of access points in communication with the CAN, each access point configured to be in wireless communication with user equipment.

19. The communication system of claim 18, further wherein the base station entity is configured to replicate the system-plane data associated with the data stream within the data sub-streams.

20. The communication system of claim 18, further wherein at least one first donor card of the plurality of donor cards is configured to communicate at least some of the system-plane data to at least one second donor card of the plurality of donor cards.
